(19) United States
(12) Patent Application Publication
(10) Pub. No.: US 2012/0017949 A1
(43) Pub. Date: Jan. 26, 2012

(54) Method and means for removing snow from the roof of a building

(76) Inventor: Joseph V. Fehringer, Columbus, NE (US)

(21) Appl. No.: 12/804,460

(22) Filed: Jul. 22, 2010

(51) Int. Cl. B08B 5/00

(52) U.S. Cl. 134/34; 15/405

(57) ABSTRACT

A method and apparatus is disclosed for blowing snow from the roof of a building. The apparatus includes a boom truck or the like such as a mobile concrete pump apparatus having a conduit extending from the vehicle to the outer end of the boom thereof. An air discharge nozzle is connected to the outer end of the conduit and an air compressor is connected to the inner end of the conduit. Upon activation of the air compressor, air is discharged from the air discharge nozzle onto and into the snow on the roof to blow the snow from the roof. The method of using the apparatus is also disclosed.

### BACKGROUND OF THE INVENTION

1. Field of the Invention

This invention relates to a method and means for removing snow from the roof of a building. More particularly, the method and means of this invention involves the use of a modified mobile concrete pump apparatus which is used to blow air through a conduit mounted thereon outwardly through an air discharge nozzle with the discharged air blowing snow from the roof of the building.

2. Description of the Related Art

The accumulation of snow on the roof of a home, garage, shed, barn or commercial building may cause the roof to collapse due to the weight of the snow. The accumulation of snow on a roof may also cause the roof to leak due to ice dams building up on the roof. Many different methods have been employed to remove snow from a roof. One method is for a person to climb onto the roof and shovel the snow therefrom. Such a method is very dangerous due to the danger of the person falling or slipping from the roof. Another method of snow removal is to rake or drag the snow from the roof. This method is time consuming, sometimes dangerous and may result in damage to the roof.

### SUMMARY OF THE INVENTION

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

A method of removing snow from the roof of a building is described. The method comprises the step of providing a vehicle mounted or mobile concrete pump apparatus including a boom structure having a plurality of movable boom sections with a conduit, having inner and outer ends, extending from the vehicle to the end of the outermost boom section. The method also includes the step of connecting a remotely controlled air discharge nozzle to the outer end of the conduit and includes the step of connecting the air discharge end of an air compressor to the inner end of the conduit. The vehicle is moved to a position adjacent the building and the boom structure thereon is manipulated so that the air discharge nozzle is positioned adjacent the snow to be removed from the roof. The air compressor is activated so that air under pressure is discharged from the air discharge nozzle into the snow on the roof to blow the snow from the roof.

The apparatus of this invention for removing snow from a roof includes a boom truck such as a mobile concrete pump apparatus including a selectively movable boom structure having a plurality of movable boom sections with a conduit, having inner and outer ends, extending from the truck to the end of the outermost boom section. A remotely controlled air discharge nozzle is positioned at the end of the conduit so as to be in communication therewith. An air compressor having an air discharge side is in communication with the inner end of the conduit so that air under pressure may be discharged from the air discharge nozzle to blow snow from the roof of a building.

In the preferred embodiment, the air discharge nozzle is selectively movable with respect to the end of the outermost boom section. The boom sections are selectively pivotally movable with respect to one another to enable the air discharge nozzle to be positioned in the desired position relative to the snow on the roof.

It is therefore a principal object of the invention to provide a method and means for removing snow from the roof of a building.

A further object of the invention is to provide a method and means for removing snow from the roof of a building through the use of a mobile concrete pump apparatus, an air compressor and an air discharge nozzle.

A further object of the invention is to provide a method and means for removing snow from the roof of a building which does not require that a person climb onto the roof to physically remove the snow therefrom.

A further object of the invention is to provide a method and means of removing snow from the roof of a building without damaging the roof of the building.

A further object of the invention is to provide a method and means for removing snow from the roof of a building by means of air.

These and other objects will be apparent to those skilled in the art.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a view illustrating the apparatus of this invention which is used to blow snow from the roof of a building;

FIG. 2 is a view of the air discharge of this invention and the means for controlling the movable nozzle associated with the invention; and

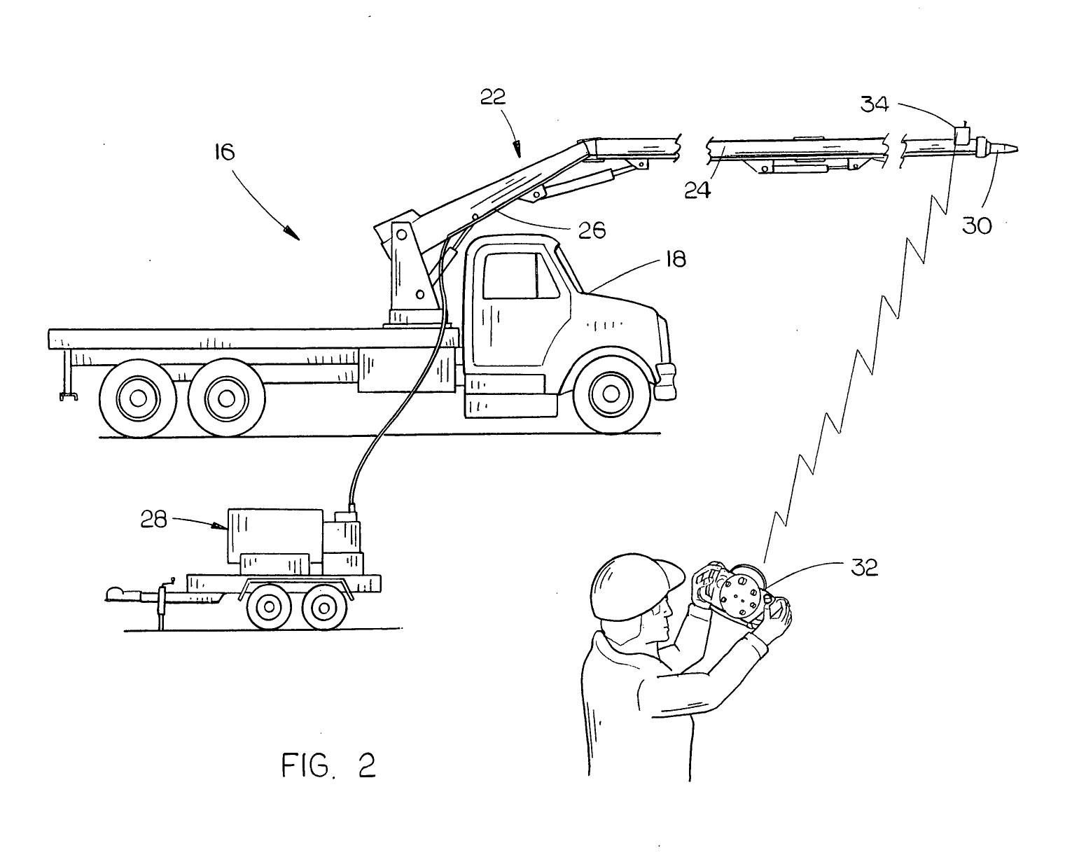

FIG. 3 is a partial perspective view illustrating the manner in which the air discharge nozzle may be selectively moved.

### DESCRIPTION OF THE PREFERRED EMBODIMENT

Embodiments are described more fully below with reference to the accompanying figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense in that the scope of the present invention is defined only by the appended claims.

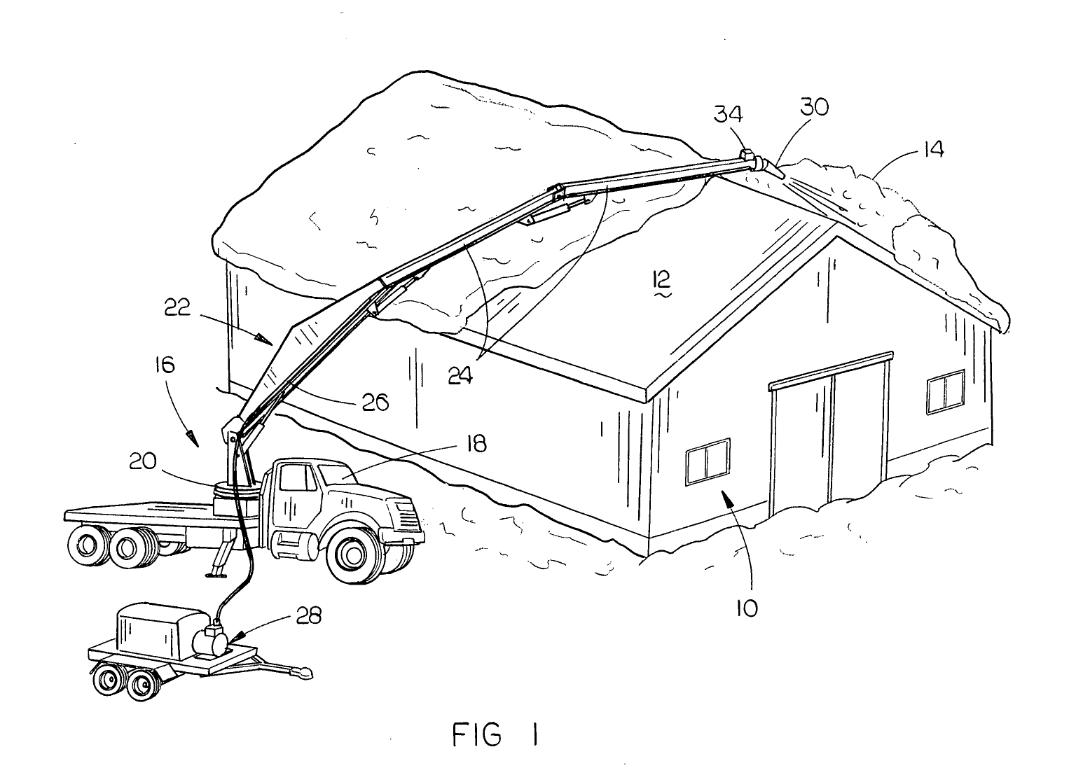

In FIG. 1, the numeral 10 refers to a building having a roof 12 upon which snow 14 has accumulated. The numeral 16 refers to a conventional mobile concrete pump apparatus such as marketed by Putzmeister America. The mobile concrete pump apparatus 16 includes a vehicle 18 having a pedestal 20 mounted thereon which supports the inner end of a boom structure 22 which is comprised of a plurality of boom sections 24 which are pivotally secured together. The numeral 26 refers to a conduit or pipe assembly which extends from a concrete pump (not shown) on the vehicle 18 to the outer end of the boom 22. As seen in the drawings, the boom sections 24 are pivotally secured together as are the sections of the conduit 26.

(a) It is preferred that a mobile concrete pump apparatus be used since it already has the conduit on pip assembly 26 provided thereon. However, a conventional boom truck could be used if a conduit or pipe assembly is added to the boom structure thereof.

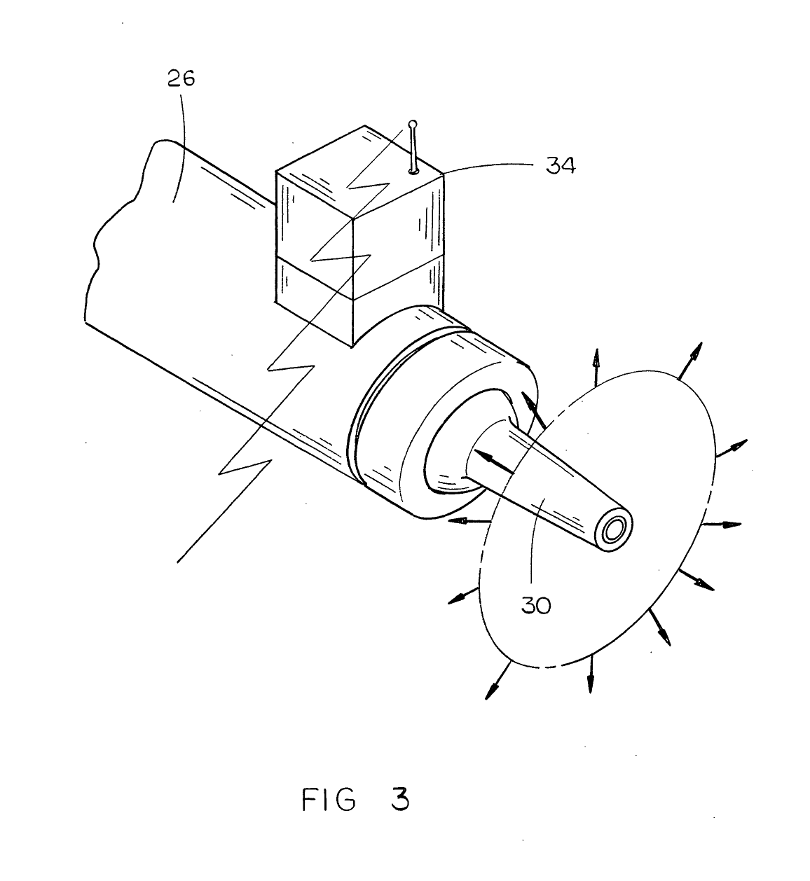

The conventional concrete pump apparatus 16 is modified slightly so as to be able to use the same to blow snow from the roof of the building 10. The inner end of the conduit 26 is disconnected from the concrete pump of the concrete pump apparatus 16 with the inner end thereof being connected to the discharge side of an air compressor 28 which is preferably mounted on a trailer or the like. The concrete pump apparatus 16 is further modified by removing the end hose from the outer end of the conduit 26 at the outer end of the outermost boom section 24. A remotely controlled air discharge nozzle 30 is then mounted on the outer end of the outermost boom section 24 with the inlet end of the air discharge nozzle 30 being connected to the end of the conduit 26. Conventional means is used to pivotally move the nozzle 30 in a 360° manner with respect to the outer end of the outermost boom section 24 as seen in FIG. 3. Means is also provided for remotely controlling the movement of the nozzle 30 by means of a radio transmitter 32 which is held by an individual and a receiver 34 mounted on the outermost boom section 24 or the conduit 26. The nozzle 30 may be selectively moved with respect to the outermost boom section 24 and the conduit 26 by means of conventional servo motors or the like. The discharge pattern of the air being discharged from nozzle 30 may be adjusted so that it may be fan-shaped, funnel-shaped, or a straight stream of air.

In use, the vehicle 18 is maneuvered with respect to the building 10 so that the boom 22 may be raised, lowered, and pivotally moved with respect to the roof 12 so that the nozzle 30 is positioned adjacent the snow 14 on the roof 12. The vehicle 18 does not have to be closely positioned to the building 10 and could be located on a street near the building and has the capability of reaching the far side of the roof 12 due to the length of the boom structure 22.

When the nozzle 30 is positioned in the desired position, the air compressor 28 is actuated so that air is blown outwardly from the air discharge nozzle 30 onto the snow on the roof to blow the snow 14 from the roof 12. Normally, one person will be controlling the boom with another person controlling the movement of the air discharge nozzle 30. In some cases, it may be necessary for the person controlling the discharge nozzle to move onto the roof of the building. However, the task could be performed by a single person.

Thus it can be seen that a novel method and means has been provided for blowing snow from the roof of a building without the need of a person or persons climbing onto the roof to physically shovel snow therefrom or without the requirement that the snow be raked or pulled from the roof. The removal of the snow from the roof of the building will significantly reduce, and perhaps eliminate, the possibility of the roof collapsing from the weight of the snow thereon.

Thus it can be seen that the invention accomplishes at least all of its stated objectives.

Although the invention has been described in language that is specific to certain structures and methodological steps, it is to be understood that the invention defined in the appended claims is not necessarily limited to the specific structures and/or steps described. Rather, the specific aspects and steps are described as forms of implementing the claimed invention. Since many embodiments of the invention can be practiced without departing from the spirit and scope of the invention, the invention resides in the claims hereinafter appended.

1. The method of removing snow from the roof of a building, comprising the steps of:
providing a vehicle mounted concrete pump apparatus including a boom structure having a plurality of movable boom sections with a conduit, having inner and outer ends, extending from the vehicle to the end of the outermost boom section;
connecting an air discharge nozzle to the outer end of the conduit;
connecting the discharge side of an air compressor to the inner end of the conduit;
moving the vehicle to a position adjacent the building;
moving the boom structure so that the air discharge nozzle is positioned adjacent the snow to be removed from the roof;
activating the air compressor so that air under pressure is discharged from the air discharge nozzle into the snow to blow the snow from the roof.

2. The method of claim 1 wherein the boom structure is extended, retracted and moved so as to move the air discharge nozzle with respect to the roof of the building.

3. The method of claim 1 wherein the air discharge nozzle is adjusted to create different air discharge patterns.

4. The method of claim 1 wherein the air compressor is mounted on a wheeled trailer or the like.

5. The method of claim 1 wherein the air discharge nozzle is remotely controlled to move the air discharge nozzle with respect to the end of the outermost boom section.

6. The method of claim 1 wherein the air discharge nozzle is pivotally movable with respect to the end of the outermost boom section.

7. The method of claim 1 wherein the boom sections are pivotally moved with respect to one another to position the air discharge nozzle in the desired position relative to the snow on the roof.

8. The method of removing snow from the roof of a building, comprising the steps of:
providing a boom truck including a boom structure having a plurality of movable boom sections with a conduit, having inner and outer ends, extending from the vehicle to the end of the outermost boom section;
connecting an air discharge nozzle to the outer end of the conduit;
connecting the discharge side of an air compressor to the inner end of the conduit;
moving the vehicle to a position adjacent the building;
moving the boom structure so that the air discharge nozzle is positioned adjacent the snow to be removed from the roof;
activating the air compressor so that air under pressure is discharged from the air discharge nozzle into the snow to blow the snow from the roof.

9. The method of claim 8 wherein the boom structure is extended, retracted and moved so as to move the air discharge nozzle with respect to the roof of the building.

10. The method of claim 8 wherein the air discharge nozzle is adjusted to create different air discharge patterns.

11. The method of claim 8 wherein the air compressor is mounted on a wheeled trailer or the like.

12. The method of claim 8 wherein the air discharge nozzle is remotely controlled to move the air discharge nozzle with respect to the end of the outermost boom section.

13. The method of claim 8 wherein the air discharge nozzle is pivotally movable with respect to the end of the outermost boom section.

14. The method of claim 8 wherein the boom sections are moved with respect to one another to position the air discharge nozzle in the desired position relative to the snow on the roof.

15. An apparatus for removing snow from the roof of a building, comprising:
a boom truck including a selectively movable boom structure having a plurality of movable boom sections with a conduit, having inner and outer ends, extending from the truck to the end of the outermost boom section;
an air discharge nozzle in communication with the outer end of the conduit;
an air compressor having an air discharge side in communication with said inner end of said conduit so that air under pressure may be discharged from said air discharge nozzle to blow snow from the roof of the building.

16. The apparatus of claim 15 wherein said air discharge nozzle is movable with respect to the end of the outermost boom section.

17. The apparatus of claim 15 wherein the air discharge nozzle is remotely controlled to move the air discharge nozzle with respect to the end of the outermost boom section.

18. The apparatus of claim 15 wherein the boom sections are pivotally secured together.

19. The apparatus of claim 15 wherein said boom truck is a concrete pump truck.

20. The apparatus of claim 15 wherein said boom sections are selectively pivotally movable with respect to one another to enable said air discharge nozzle to be positioned in the desired position relative to the snow on the roof.
